(19) United States
(12) Patent Application Publication
(10) Pub. No.: US 2011/0273544 A1
(43) Pub. Date: Nov. 10, 2011

(54) Shutter driving device and three-dimensional video display system

(75) Inventors: Sho Mitsuishi, Fukuoka (JP); Toshio Suzuki, Kanagawa (JP); Seigou Sakai, Nagasaki (JP)

(73) Assignee: Sony Corporation, Tokyo (JP)

(21) Appl. No.: 13/064,402

(22) Filed: Mar. 23, 2011

(30) Foreign Application Priority Data
May 6, 2010 (JP) 2010-106391

(51) Int. Cl. H04N 13/04

(52) U.S. Cl. 348/56; 348/E13.026

(57) ABSTRACT

Disclosed herein is a shutter driving device that drives a first shutter including a first driving-subject capacitive load and a second shutter including a second driving-subject capacitive load. The shutter driving device includes a power recovery unit, a first driving path, a second driving path, a third driving path, a first clamp circuit, a second clamp circuit, a third clamp circuit, a power recovery path, and a recovery control switch configured to be disposed on the power recovery path.

### BACKGROUND OF THE INVENTION

1. Field of the Invention

The present invention relates to a shutter driving device and a three-dimensional video display system that drive shutters of three-dimensional (3D) glasses to express three-dimensional stereoscopic view video.

2. Description of the Related Art

FIG. 1 is a diagram showing the concept of 3D glasses.

As shown in FIG. 1, in 3D glasses 1, liquid crystal shutters 2 and 3 are disposed at parts equivalent to the left and right lenses of general glasses.

The liquid crystal (LC) shutters 2 and 3 are turned on and off by a shutter driving device in synchronization with video displaying and thereby three-dimensional stereoscopic view video is expressed.

FIG. 2 is a circuit diagram showing a configuration example of a general shutter driving device.

A shutter driving device 4 is integrated as a driver IC.

The shutter driving device 4 has clamp circuits 5, 6, 7, and 8.

The clamp circuit 5 clamps one end side of a capacitive load 2a of the liquid crystal shutter 2 to a supply potential VDD or a reference potential VSS via a terminal T1.

The clamp circuit 6 clamps the other end side of the capacitive load 2a of the liquid crystal shutter 2 to the supply potential VDD or the reference potential VSS via a terminal T2.

The clamp circuit 7 clamps one end side of a capacitive load 3a of the liquid crystal shutter 3 to the supply potential VDD or the reference potential VSS via a terminal T3.

The clamp circuit 8 clamps the other end side of the capacitive load 3a of the liquid crystal shutter 3 to the supply potential VDD or the reference potential VSS via a terminal T4.

The clamp circuit 5 is formed with a p-channel MOS (PMOS) transistor PT1 and an n-channel MOS (NMOS) transistor NT1.

The source of the PMOS transistor PT1 is connected to the power supply VDD and its drain is connected to the terminal T1.

The source of the NMOS transistor NT1 is connected to the reference potential VSS and its drain is connected to the drive terminal T1.

The PMOS transistor PT1 and the NMOS transistor NT1 are turned on and off in a complementary manner by a signal SS1 supplied to their gates.

The clamp circuit 6 is formed with a PMOS transistor PT2 and an NMOS transistor NT2.

The source of the PMOS transistor PT2 is connected to the power supply VDD and its drain is connected to the terminal T2.

The source of the NMOS transistor NT2 is connected to the reference power supply VSS and its drain is connected to the terminal T2.

The PMOS transistor PT2 and the NMOS transistor NT2 are turned on and off in a complementary manner by a signal SC1 supplied to their gates.

The clamp circuit 7 is formed with a PMOS transistor PT3 and an NMOS transistor NT3.

The source of the PMOS transistor PT3 is connected to the power supply VDD and its drain is connected to the terminal T3.

The source of the NMOS transistor NT3 is connected to the reference power supply VSS and its drain is connected to the terminal T3.

The PMOS transistor PT3 and the NMOS transistor NT3 are turned on and off in a complementary manner by a signal SS2 supplied to their gates.

The clamp circuit 8 is formed with a PMOS transistor PT4 and an NMOS transistor NT4.

The source of the PMOS transistor PT4 is connected to the power supply VDD and its drain is connected to the terminal T4.

The source of the NMOS transistor NT4 is connected to the reference power supply VSS and its drain is connected to the terminal T4.

The PMOS transistor PT4 and the NMOS transistor NT4 are turned on and off in a complementary manner by a signal SC2 supplied to their gates.

The shutter driving device 4 turns on and off the shutters by applying a voltage at the level of the power supply VDD and a voltage at the level of the reference potential VSS to the capacitive loads 2a and 3a as the driving subjects of the liquid crystal shutters 2 and 3 by the clamp circuits 5, 6, 7, and 8.

### SUMMARY OF THE INVENTION

The 3D glasses are often driven by a battery in terms of handleability and so forth.

For the liquid crystal shutter driving device in the 3D glasses, driving with low power consumption is indispensable to allow long-time continuous operation by a small battery because of its use purpose.

However, in the above-described shutter driving device, the liquid crystal shutters 2 and 3 are directly driven by the transistors connected to the power supply VDD and the reference potential VSS. Therefore, the power consumption is high and reduction in the power consumption is difficult. Thus, there is a fear that a sufficient use time cannot be obtained with a small battery.

There is a desire for the present invention to provide a shutter driving device and a three-dimensional video display system capable of achieving power consumption reduction and obtaining a sufficient use time of three-dimensional glasses even in driving by a small battery.

According to a first embodiment of the present invention, there is provided a shutter driving device that drives a first shutter including a first driving-subject capacitive load and a second shutter including a second driving-subject capacitive load, the shutter driving device including:

a power recovery unit configured to have at one power recovery capacitor including a function to output an intermediate voltage between a supply potential and a reference potential and a power recovery function for recovering power;

a first driving path;

a second driving path;

a third driving path;

a first clamp circuit configured to be capable of clamping one end side of the first driving-subject capacitive load to the supply potential or the reference potential via the first driving path;

a second clamp circuit configured to be capable of clamping one end side of the second driving-subject capacitive load to the supply potential or the reference potential via the second driving path;

a third clamp circuit configured to be capable of clamping the other end side of the first driving-subject capacitive load and the other end side of the second driving-subject capacitive load to the supply potential or the reference potential via the third driving path;

a power recovery path configured to connect the power recovery capacitor to any of the one end side of the first driving-subject capacitive load, the one end side of the second driving-subject capacitive load, the other end side of the first driving-subject capacitive load, and the other end side of the second driving-subject capacitive load; and

a recovery control switch configured to be disposed on the power recovery path.

According to a second embodiment of the present invention, there is provided a three-dimensional video display system including:

video display apparatus configured to include a display device; and

three-dimensional glasses configured to include a shutter driving device that drives a first shutter including a first driving-subject capacitive load and a second shutter including a second driving-subject capacitive load, and obtain three-dimensional stereoscopic view video through viewing of the display device, wherein

the video display apparatus includes a communication unit capable of transmitting a synchronizing signal of video to the three-dimensional glasses,

the three-dimensional glasses include
a communication unit capable of receiving a synchronizing signal transmitted from the communication unit of the video display apparatus, and
a controller that carries out driving control of the shutter driving device at a timing synchronized with the received synchronizing signal, and
the shutter driving device having
a power recovery unit having one power recovery capacitor including a function to output an intermediate voltage between a supply potential and a reference potential and a power recovery function for recovering power,
a first driving path,
a second driving path,
a third driving path,
a first clamp circuit capable of clamping one end side of the first driving-subject capacitive load to the supply potential or the reference potential via the first driving path,
a second clamp circuit capable of clamping one end side of the second driving-subject capacitive load to the supply potential or the reference potential via the second driving path,
a third clamp circuit capable of clamping the other end side of the first driving-subject capacitive load and the other end side of the second driving-subject capacitive load to the supply potential or the reference potential via the third driving path,
a power recovery path that connects the power recovery capacitor to any of the one end side of the first driving-subject capacitive load, the one end side of the second driving-subject capacitive load, the other end side of the first driving-subject capacitive load, and the other end side of the second driving-subject capacitive load, and
a recovery control switch disposed on the power recovery path.

The embodiments of the present invention can achieve power consumption reduction and obtain a sufficient use time of three-dimensional glasses even in driving by a small battery.

### BRIEF DESCRIPTION OF THE DRAWINGS

FIG. 1 is a diagram showing the concept of 3D glasses;

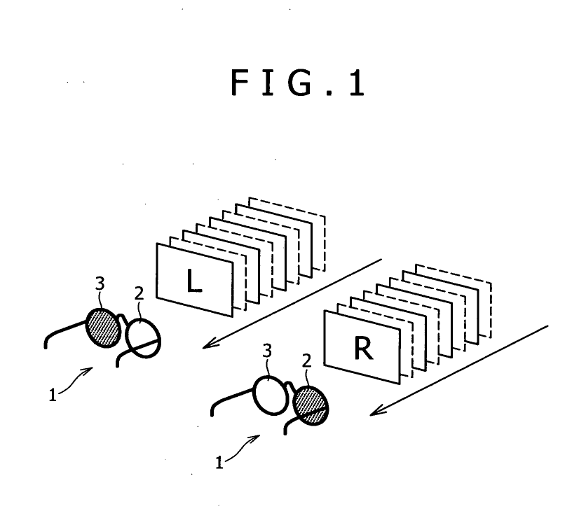

FIG. 2 is a circuit diagram showing a configuration example of a general shutter driving device;

FIG. 3 is a diagram showing the outline of the appearance of a three-dimensional video display system according to embodiments of the present invention;

FIG. 4 is a block diagram showing a configuration example of the three-dimensional video display system according to the embodiments of the present invention;

FIG. 5 is a circuit diagram showing a configuration example of a shutter driving device according to a first embodiment of the present invention;

FIGS. 6A and 6B are diagrams for explaining operation and consumption current in a first driving operation pattern in a comparative example;

FIGS. 7A and 7B are diagrams for explaining operation and consumption current in the first driving operation pattern in the first embodiment;

FIGS. 8A and 8B are diagrams for explaining operation and consumption current in a second driving operation pattern in the comparative example;

FIGS. 9A and 9B are diagrams for explaining operation and consumption current in the second driving operation pattern in the first embodiment;

FIGS. 10A and 10B are diagrams for explaining operation and consumption current in a third driving operation pattern in the comparative example;

FIGS. 11A and 11B are diagrams for explaining operation and consumption current in the third driving operation pattern in the first embodiment;

FIGS. 12A and 12B are diagrams for explaining operation and consumption current in a fourth driving operation pattern in the comparative example;

FIGS. 13A and 13B are diagrams for explaining operation and consumption current in the fourth driving operation pattern in the first embodiment;

FIG. 14 is a circuit diagram showing a configuration example of a shutter driving device according to a second embodiment of the present invention;

FIG. 15 is a timing chart for explaining the operation of the shutter driving device according to the second embodiment;

FIG. 16 is a circuit diagram showing a configuration example of a shutter driving device according to a third embodiment of the present invention;

FIG. 17 is a circuit diagram showing a configuration example of a shutter driving device according to a fourth embodiment of the present invention; and

FIG. 18 is a circuit diagram showing a configuration example of a shutter driving device according to a fifth embodiment of the present invention.

### DETAILED DESCRIPTION OF THE PREFERRED EMBODIMENTS

Embodiments of the present invention will be described below in association with the drawings.

The order of the description is as follows.
1. First Embodiment (first configuration example of shutter driving device)
2. Second Embodiment (second configuration example of shutter driving device)
3. Third Embodiment (third configuration example of shutter driving device)
4. Fourth Embodiment (fourth configuration example of shutter driving device)
5. Fifth Embodiment (fifth configuration example of shutter driving device)

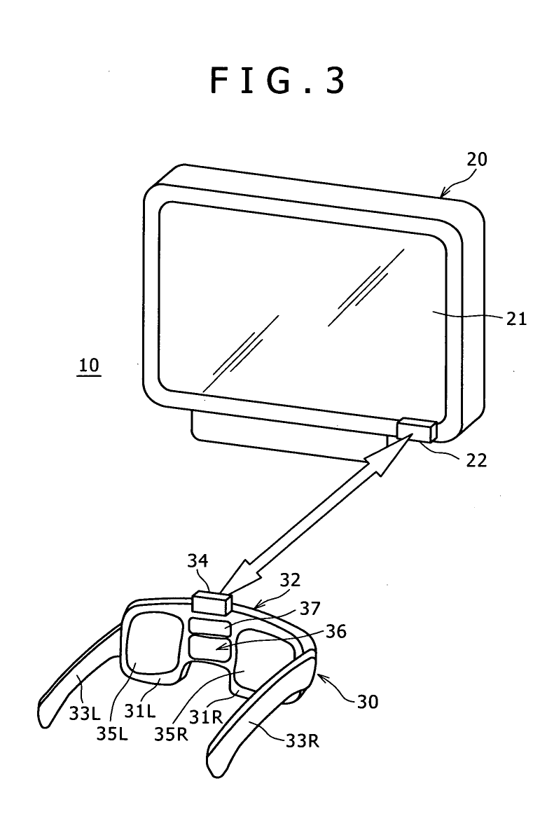

FIG. 3 is a diagram showing the outline of the appearance of a three-dimensional video display system according to the embodiments of the present invention.

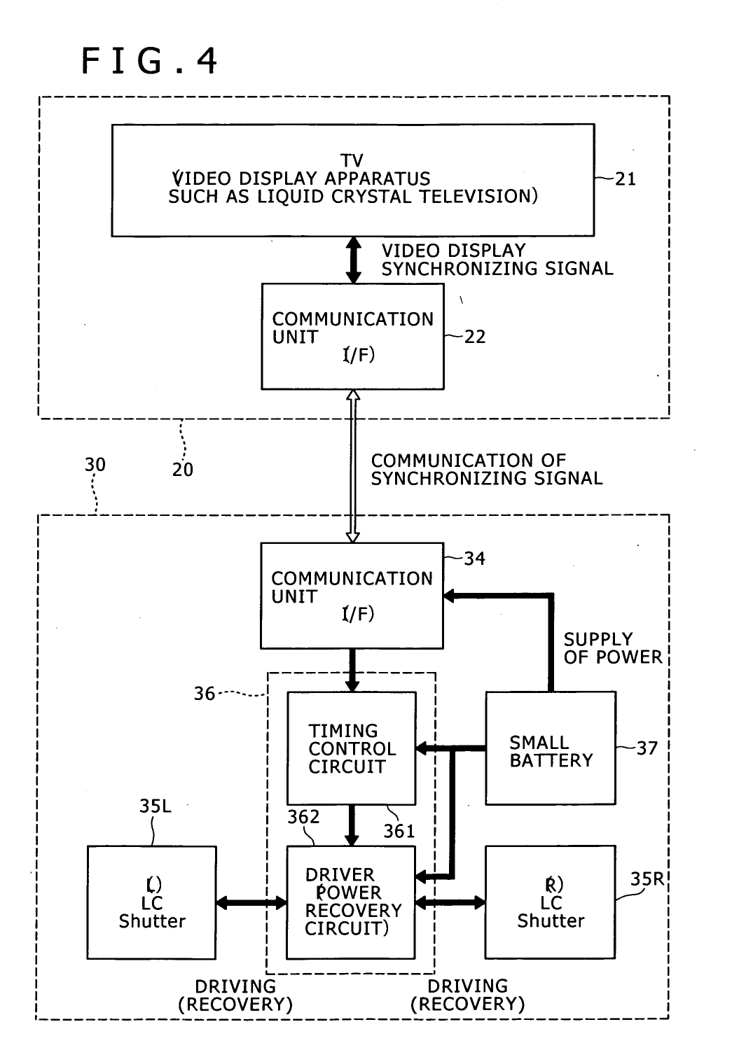

FIG. 4 is a block diagram showing a configuration example of the three-dimensional video display system according to the embodiments of the present invention.

This three-dimensional (3D) video display system 10 is formed with video display apparatus 20 and a 3D-glasses main body 30.

The video display apparatus 20 has a display device 21 and a communication unit 22.

The display device 21 is formed of e.g. liquid crystal television (TV) apparatus and displays stereoscopically-viewed video in association with driving of the 3D-glasses main body 30.

The communication unit 22 has a function to transmit synchronizing signals of video displaying and so forth and receive information from the 3D-glasses main body 30 so that the 3D-glasses main body 30 may perform shutter driving in synchronization with the displaying by the display device 21.

The synchronizing signals of video displaying, transmitted to the 3D-glasses main body 30 by the communication unit 22, include e.g. a vertical synchronizing signal VSYNC.

The communication unit 22 wirelessly communicates with the 3D-glasses main body 30. As this wireless communication, e.g. infrared (IR) communication is used.

The 3D-glasses main body 30 has rims 31R and 31L, a bridge 32 formed between the rims, and temples 33R and 33L, similarly to normal glasses.

Furthermore, the 3D-glasses main body 30 includes a communication unit 34, liquid crystal (LC) shutters 35R and 35L, a shutter driving device (driver IC) 36, and a small battery 37.

The LC shutter 35R forms the first shutter and the LC shutter 35L forms the second shutter.

The LC shutter 35R is fixed to the rim 31R and the LC shutter 35L is fixed to the rim 31L.

On the inner surface side of the bridge 32 (face side), the communication unit 34, the shutter driving device 36, and the small battery 37 are disposed.

The communication unit 34 has a function to receive the vertical synchronizing signal VSYNC of video displaying and so forth, transmitted by the communication unit 22 of the video display apparatus 20 for shutter driving by the 3D-glasses main body 30 in synchronization with displaying by the display device 21.

The communication unit 34 supplies the received vertical synchronizing signal VSYNC to the shutter driving device 36.

The shutter driving device 36 controls the driving timing of the LC shutters 35R and 35L in synchronization with the vertical synchronizing signal VSYNC received by the communication unit 34, and drives the LC shutters 35R and 35L in accordance with this driving timing.

The shutter driving device 36 is configured by integrating, into an IC, a timing control circuit 361 to control the driving timing of the LC shutters 35R and 35L and a driver 362 to drive the LC shutters 35R and 35L in accordance with the control by the timing control circuit 361.

The driver IC of the shutter driving device 36 has a function to control ON/OFF of the LC shutters 35R and 35L by applying, to the LC shutters 35R and 35L, potential at the level of the supply potential VDD and a potential at the level of the reference potential VSS such as a potential at the level of the ground GND.

The shutter driving device 36 alternately opens and closes the left and right LC shutters 35R and 35L in association with video displaying in this manner, to thereby obtain stereoscopic view video.

In the shutter driving device 36, for output to the driving-subject capacitive loads of the LC shutters 35R and 35L, a power supply for power recovery (power recovery capacitor) and clamp circuits for clamping to the supply potential VDD and the reference potential VSS such as the GND potential are used.

The shutter driving device 36 has a power recovery function by use of a capacitor and switches for power consumption reduction.

The shutter driving device 36 according to the embodiments realizes great power consumption reduction by the power recovery function.

The shutter driving device of the embodiments employs driving with inversion at every one-field period of the common voltage VCOM, carried out for power consumption reduction in liquid crystal driving.

Furthermore, the shutter driving device according to the embodiments uses the power recovery configuration also in the driving with inversion of the common voltage to thereby allow great reduction in the power consumption.

Five specific configuration examples of the shutter driving device 36 will be described below as a first embodiment, a second embodiment, a third embodiment, a fourth embodiment, and a fifth embodiment of the present invention.

In the following description, the shutter driving device 36 is represented by numeral 100.

### 1. First Embodiment

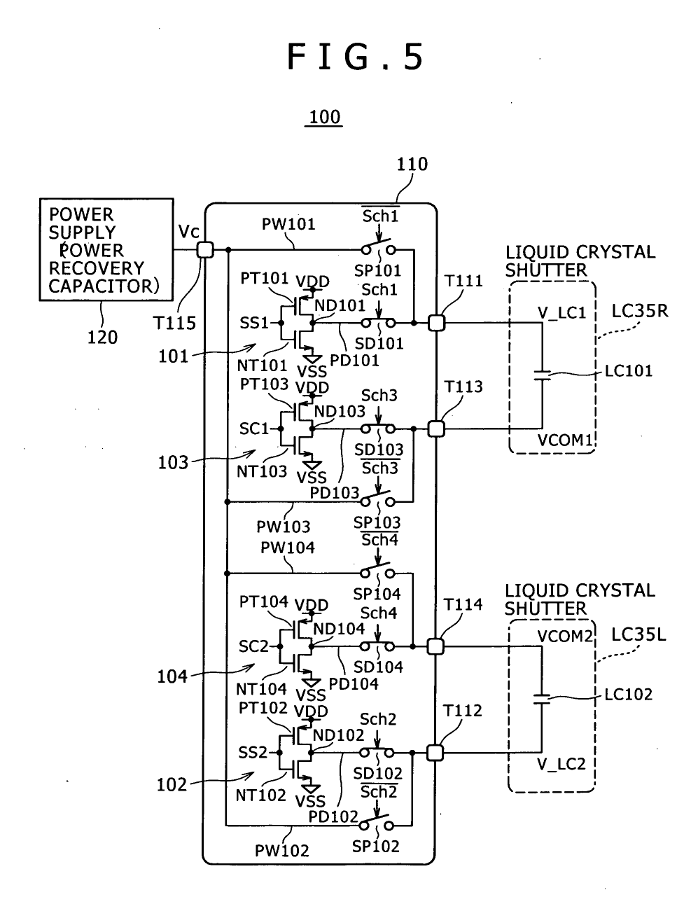

FIG. 5 is a circuit diagram showing a configuration example of a shutter driving device according to the first embodiment of the present invention.

The shutter driving device 100 of FIG. 5 has a driver IC 110 and a power supply 120 including a power recovery capacitor.

The driver IC 110 has connection terminals T111, T112, T113, and T114.

One end of a first driving-subject capacitive load LC101 is connected to the connection terminal T111 and the other end thereof is connected to the connection terminal T113.

One end of a second driving-subject capacitive load LC102 is connected to the connection terminal T112 and the other end thereof is connected to the connection terminal T114.

The input/output part of the power supply 120 is connected to a terminal T115.

The shutter driving device 100 has a first clamp circuit 101, a second clamp circuit 102, a third clamp circuit 103, and a fourth clamp circuit 104.

The shutter driving device 100 has a first driving path PD101, a second driving path PD102, a third driving path PD103, and a fourth driving path PD104.

The first driving path PD101 is connected between a node ND101 of the first clamp circuit 101 and the connection terminal T111, and the second driving path. PD102 is connected between a node ND102 of the second clamp circuit 102 and the connection terminal T112.

The third driving path PD103 is connected between a node ND103 of the third clamp circuit 103 and the connection terminal T113, and the fourth driving path PD104 is connected between a node ND104 of the fourth clamp circuit 104 and the connection terminal T114.

The shutter driving device 100 has a first power recovery path PW101, a second power recovery path PW102, a third power recovery path PW103, and a fourth power recovery path PW104.

The first power recovery path PW101 is connected between the connection terminal T115 and the connection terminal T111, and the second power recovery path PW102 is connected between the connection terminal T115 and the connection terminal T112.

The third power recovery path PW103 is connected between the connection terminal T115 and the connection terminal T113, and the fourth power recovery path PW104 is connected between the connection terminal T115 and the connection terminal T114.

That is, in the present embodiment, one end part of each of the first power recovery path PW101, the second power recovery path PW102, the third power recovery path PW103, and the fourth power recovery path PW104 is connected to the connection terminal T115 in common.

The shutter driving device 100 has a first driving control switch SD101, a second driving control switch SD102, a third driving control switch SD103, and a fourth driving control switch SD104.

The first driving control switch SD101 is disposed on the first driving path PD101, and its on/off-state is controlled by a signal Sch1 by the timing control circuit 361 as the controller.

When the first driving control switch SD101 is kept in the off-state, the node ND101 of the first clamp circuit 101 is kept at high impedance (Hi-Z).

The second driving control switch SD102 is disposed on the second driving path PD102, and its on/off-state is controlled by a signal Sch2 by the timing control circuit 361 as the controller.

When the second driving control switch SD102 is kept in the off-state, the node ND102 of the second clamp circuit 102 is kept at high impedance (Hi-Z).

The third driving control switch SD103 is disposed on the third driving path PD103, and its on/off-state is controlled by a signal Sch3 by the timing control circuit 361 as the controller.

When the third driving control switch SD103 is kept in the off-state, the node ND103 of the third clamp circuit 103 is kept at high impedance (Hi-Z).

The fourth driving control switch SD104 is disposed on the fourth driving path PD104, and its on/off-state is controlled by a signal Sch4 by the timing control circuit 361 as the controller.

When the fourth driving control switch SD104 is kept in the off-state, the node ND104 of the fourth clamp circuit 104 is kept at high impedance (Hi-Z).

The shutter driving device 100 has a first recovery control switch SP101, a second recovery control switch SP102, a third recovery control switch SP103, and a fourth recovery control switch SP104.

The first recovery control switch SP101 is disposed on the first recovery path PW101, and its on/off-state is controlled by an inverted signal S̅c̅h̅1̅ of the signal Sch1 by the timing control circuit 361 as the controller so that it may be turned on and off in a complementary manner with the first driving control switch SD101.

The second recovery control switch SP102 is disposed on the second recovery path PW102, and its on/off-state is controlled by an inverted signal S̅c̅h̅2̅ of the signal Sch2 by the timing control circuit 361 as the controller so that it may be turned on and off in a complementary manner with the second driving control switch SD102.

The third recovery control switch SP103 is disposed on the third recovery path PW103, and its on/off-state is controlled by an inverted signal S̅c̅h̅3̅ of the signal Sch3 by the timing control circuit 361 as the controller so that it may be turned on and off in a complementary manner with the third driving control switch SD103.

The fourth recovery control switch SP104 is disposed on the fourth recovery path PW104, and its on/off-state is controlled by an inverted signal S̅c̅h̅4̅ of the signal Sch4 by the timing control circuit 361 as the controller so that it may be turned on and off in a complementary manner with the fourth driving control switch SD104.

In the shutter driving device 100, the driver IC 110 is formed through integration of the above-described respective constituent elements except the power supply 120.

The first clamp circuit 101 is so controlled as to be capable of clamping one end side of the first driving-subject capacitive load LC101 to the level of a supply potential VDD or a reference potential VSS via the first driving path PD101 and the first driving control switch SD101.

The clamp potential of the first clamp circuit 101 is controlled to the level of the supply potential VDD or the reference potential VSS by a signal SS1 by the timing control circuit 361 as the controller.

The first clamp circuit 101 is formed with a PMOS transistor PT101 as the power-supply-side connection switch and an NMOS transistor NT101 as the reference-side connection switch.

The source of the PMOS transistor PT101 is connected to the power supply VDD and its drain is connected to the node ND101 connected to the first driving path PD101.

The source of the NMOS transistor NT101 is connected to the reference potential VSS and its drain is connected to the node ND101 connected to the first driving path PD101.

The PMOS transistor PT101 and the NMOS transistor NT101 are turned on and off by the signal SS1 by the timing control circuit 361 as the controller.

The second clamp circuit 102 is so controlled as to be capable of clamping one end side of the second driving-subject capacitive load LC102 to the level of the supply potential VDD or the reference potential VSS via the second driving path PD102 and the second driving control switch SD102.

The clamp potential of the second clamp circuit 102 is controlled to the level of the supply potential VDD or the reference potential VSS by a signal SS2 by the timing control circuit 361 as the controller.

The second clamp circuit 102 is formed with a PMOS transistor PT102 as the power-supply-side connection switch and an NMOS transistor NT102 as the reference-side connection switch.

The source of the PMOS transistor PT102 is connected to the power supply VDD and its drain is connected to the node ND102 connected to the second driving path PD102.

The source of the NMOS transistor NT102 is connected to the reference potential VSS and its drain is connected to the node ND102 connected to the second driving path PD102.

The PMOS transistor PT102 and the NMOS transistor NT102 are turned on and off by the signal SS2 by the timing control circuit 361 as the controller.

The third clamp circuit 103 is so controlled as to be capable of clamping the other end side of the first driving-subject capacitive load LC101 to the level of the supply potential VDD or the reference potential VSS as a common voltage VCOM via the third driving path PD103 and the third driving control switch SD103.

The clamp potential of the third clamp circuit 103 is controlled to the level of the supply potential VDD or the reference potential VSS by a signal SC1 by the timing control circuit 361 as the controller.

The third clamp circuit 103 is formed with a PMOS transistor PT103 as the power-supply-side connection switch and an NMOS transistor NT103 as the reference-side connection switch.

The source of the PMOS transistor PT103 is connected to the power supply VDD and its drain is connected to the node ND103 connected to the third driving path PD103.

The source of the NMOS transistor NT103 is connected to the reference potential VSS and its drain is connected to the node ND103 connected to the third driving path PD103.

The PMOS transistor PT103 and the NMOS transistor NT103 are turned on and off by the signal SC1 by the timing control circuit 361 as the controller.

The fourth clamp circuit 104 is so controlled as to be capable of clamping the other end side of the second driving-subject capacitive load LC102 to the level of the supply potential VDD or the reference potential VSS as the common voltage VCOM via the fourth driving path PD104 and the fourth driving control switch SD104.

The clamp potential of the fourth clamp circuit 104 is controlled to the level of the supply potential VDD or the reference potential VSS by a signal SC2 by the timing control circuit 361 as the controller.

The fourth clamp circuit 104 is formed with a PMOS transistor PT104 as the power-supply-side connection switch and an NMOS transistor NT104 as the reference-side connection switch.

The source of the PMOS transistor PT104 is connected to the power supply VDD and its drain is connected to the node ND104 connected to the fourth driving path PD104.

The source of the NMOS transistor NT104 is connected to the reference potential VSS and its drain is connected to the node ND104 connected to the fourth driving path PD104.

The PMOS transistor PT104 and the NMOS transistor NT104 are turned on and off by the signal SC2 by the timing control circuit 361 as the controller.

The input/output part of the power supply 120 as a power recovery capacitor unit is connected to the first recovery path PW101, the second recovery path PW102, the third recovery path PW103, and the fourth recovery path PW104 via the connection terminal T115.

The power supply 120 includes a function to apply an intermediate voltage between the supply potential VDD and the reference potential VSS to its connection node and a power recovery function for recovering power.

The power supply 120 sets an intermediate voltage V1 applied to the connection node GND to e.g. the half value of both potentials, (VDD+VSS)/2, in view of the power recovery efficiency.

However, this intermediate voltage V1 can be set to any value between both potentials except the supply potential VDD and the reference potential VSS, and the value other than the half value can also realize power recovery and power consumption reduction although the power recovery efficiency is lower compared with the half value.

The following description is based on the assumption that the intermediate voltage is set to VDD/2.

### Operation of Shutter Driving Device 100 of First Embodiment

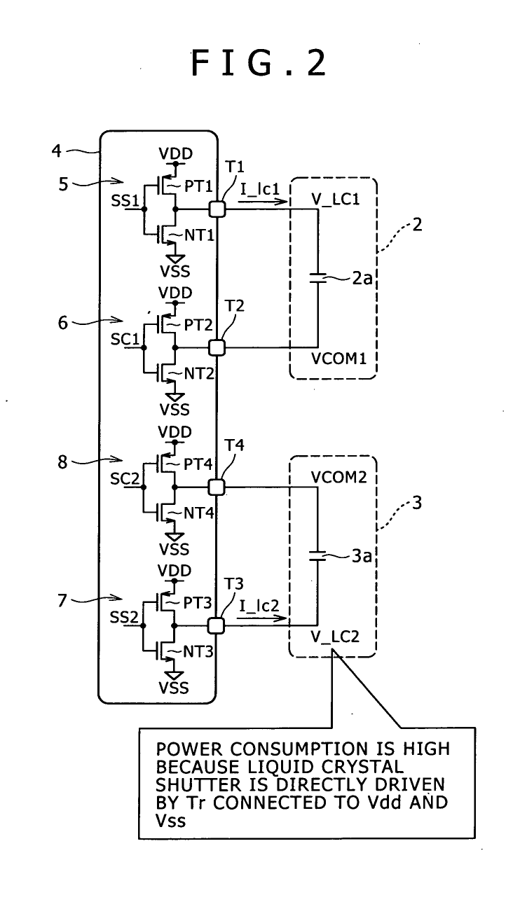

The operation of the shutter driving device 100 having the above-described configuration will be described below with comparison with the shutter driving device of FIG. 2 as a comparative example.

The capacitance of the power recovery capacitor 121 needs to be set sufficiently higher than the capacitance of the liquid crystal shutter load.

As the driving operation pattern of the shutter driving device 100, the following four driving operation patterns exist.

In a first driving operation pattern PTN1, voltage transition occurs in such a direction that the voltages of both ends of the driving-subject capacitive load get away from each other.

In a second driving operation pattern PTN2, voltage transition occurs in such a direction that the voltages of both ends of the driving-subject capacitive load get close to each other.

In a third driving operation pattern PTN3, simultaneous transition in the same direction occurs in the voltages of both ends of the driving-subject capacitive load.

In a fourth driving operation pattern PTN4, simultaneous transition in the reverse directions occurs in the voltages of both ends of the driving-subject capacitive load.

The consumption current in the configuration of the present embodiment and the configuration of the comparative example of FIG. 2 will be discussed below for each of these driving operation patterns.

[PTN1: Voltage Transition in such a Direction that the Voltages of Both Ends of the Driving-Subject Capacitive Load Get Away from Each Other]

First, the first driving operation pattern PTN1, in which voltage transition occurs in such a direction that the voltages of both ends of the driving-subject capacitive load get away from each other, will be described below.

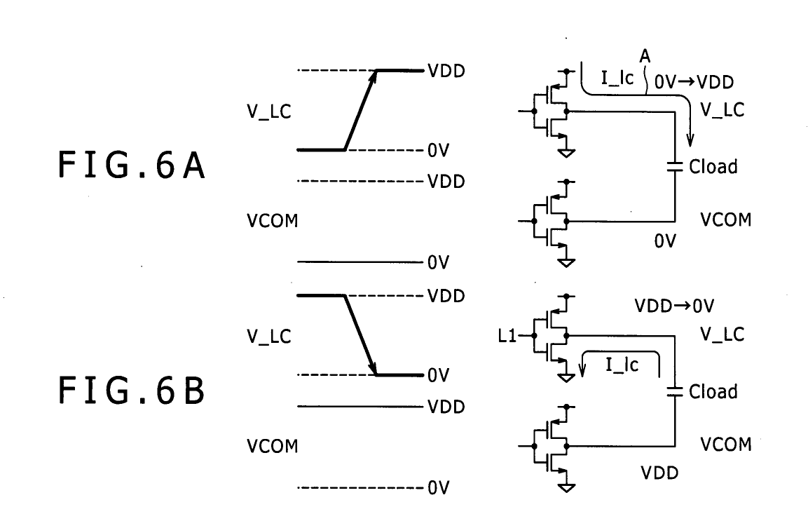

FIGS. 6A and 6B are diagrams for explaining operation and consumption current in the first driving operation pattern PTN1 in the comparative example.

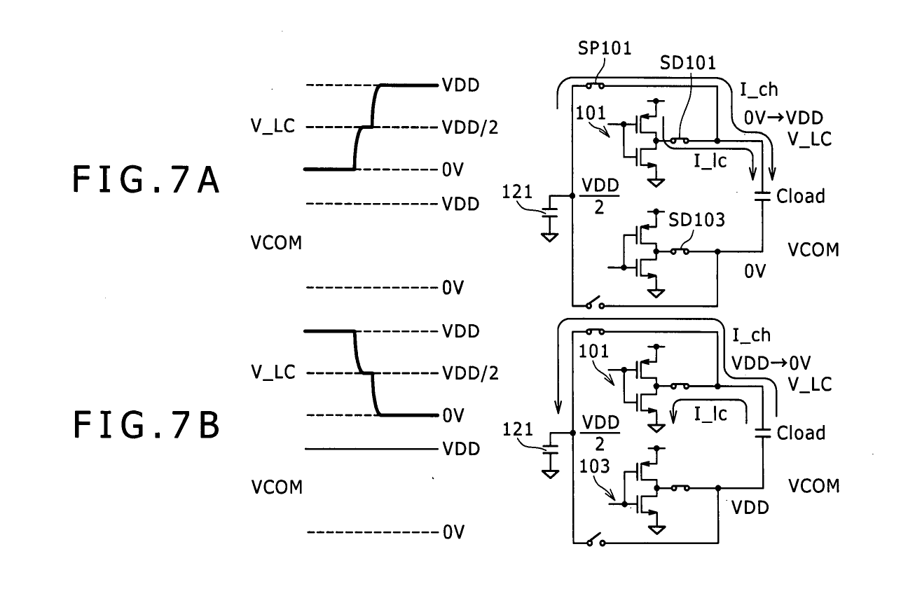

FIGS. 7A and 7B are diagrams for explaining operation and consumption current in the first driving operation pattern PTN1 in the present embodiment.

In the diagrams, I_lc denotes the driving-subject capacitive load current. I_ch denotes the power recovery current. Cload denotes the driving capacitance. VDD denotes a transition voltage. VDD/2 denotes a transition voltage.

FIGS. 6A and 6B show the waveform and equivalent circuit of the transition operation of the voltage V_LC when the common voltage VCOM is fixed in the comparative example.

FIG. 6A shows charge operation of the driving-subject capacitive load and FIG. 6B shows discharge operation of the driving-subject capacitive load.

The operation when the V_LC side is fixed and transition occurs in the common voltage VCOM is the same as the operation described below, and therefore description thereof is omitted.

In the charge operation, a current is charged from VDD to the driving-subject capacitive load through the path indicated by arrowhead A in the circuit diagram. The average value of the current at this time is determined by the load capacitance Cload, the transition voltage VDD, and the frame cycle T and is represented by the following equation.

I_{—}lc=Cload×VDD×1/T (1)

If a similar way of thinking is applied also to the discharge operation, it turns out that the same current as that in the charge operation flows.

Specifically, the average value of the consumption current in discharge of the driving-subject capacitive load from VDD to 0 V can also be represented by the above-described equation (1).

FIGS. 7A and 7B show the voltage waveform and equivalent circuit in charge and discharge of the driving-subject capacitive load by the shutter driving device 100 according to the present embodiment.

First, as the operation of power recovery, if the voltage of the power recovery capacitor 121 of the power supply 120 is set to VDD/2, the operation in charge of the driving-subject capacitive load is as follows. Specifically, a current is supplied from the power recovery capacitor 121 in voltage transition from 0 V to VDD/2, and a current is supplied from VDD in transition from VDD/2 to VDD.

In discharge, a current is recovered to the power recovery capacitor 121 in transition from VDD to VDD/2, and voltage transition is performed by leading (discarding) a current to the reference potential VSS in transition from VDD/2 to 0 V.

Thus, the current consumed from VDD is the current in the transition from VDD/2 to VDD and therefore is represented by the following equation.

$$I\_lc = Cload \times \frac{VDD}{2} \times 1 / T \qquad ( 2 )$$

Also in the discharge, the current is represented by this equation (2), and the consumption current is about half that in the comparative example.

Furthermore, the current supplied or recovered from or to the power recovery capacitor 121 is represented by the following equation (3), and the power consumption is about half that in the comparative example.

$$I\_ch = Cload \times \frac{VDD}{2} \times 1 / T \qquad ( 3 )$$

As just described, in the present embodiment, half of the consumed power in the comparative example is accumulated in the power recovery capacitor 121 and the charge is reused in the next transition to thereby reduce the power consumption.

[PTN2: Voltage Transition in Such a Direction that the Voltages of Both Ends of the Driving-Subject Capacitive Load get Close to Each Other]

Next, the second driving operation pattern PTN2, in which voltage transition occurs in such a direction that the voltages of both ends of the driving-subject capacitive load get close to each other, will be described below.

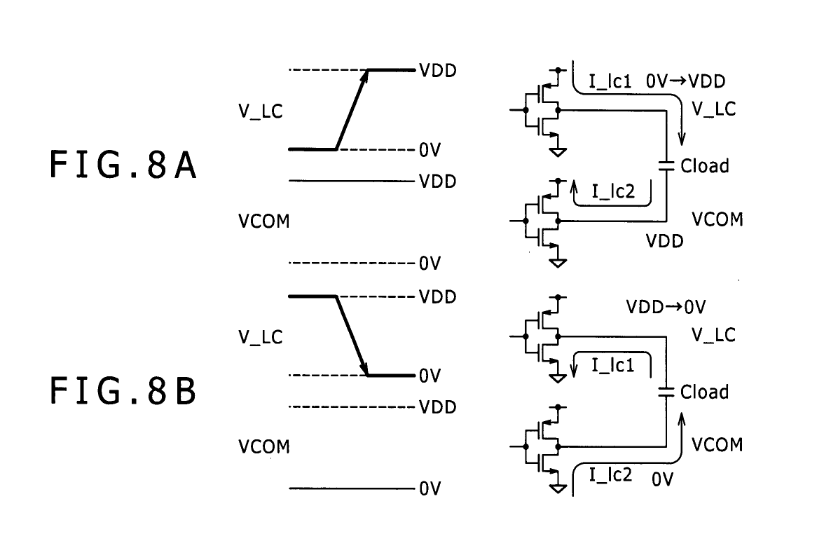

FIGS. 8A and 8B are diagrams for explaining operation and consumption current in the second driving operation pattern PTN2 in the comparative example.

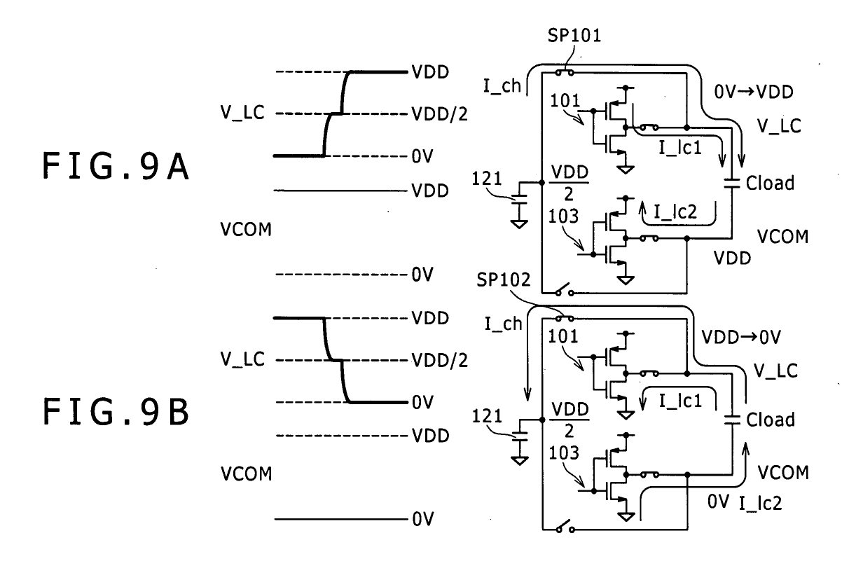

FIGS. 9A and 9B are diagrams for explaining operation and consumption current in the second driving operation pattern PTN2 in the present embodiment.

In the diagrams, I_lc denotes the driving-subject capacitive load current. I_ch denotes the power recovery current. Cload denotes the driving capacitance. VDD denotes a transition voltage. VDD/2 denotes a transition voltage.

FIGS. 8A and 8B show the waveform and equivalent circuit of the transition operation of the voltage V_LC when the common voltage VCOM is fixed in the comparative example.

FIG. 8A shows charge operation of the driving-subject capacitive load and FIG. 8B shows discharge operation of the driving-subject capacitive load.

The operation when the V_LC side is fixed and transition occurs in the common voltage VCOM is the same as the operation described below, and therefore description thereof is omitted.

As the operation in charge, the V_LC side, which is one end side of the driving-subject capacitive load, is connected to VDD and charged. Furthermore, the side of the common voltage VCOM (the other end side) is instantaneously boosted up to 2VDD because the driving-subject capacitive load originally has a potential difference of VDD.

Thus, the same current I_lcl as the current in the first driving operation pattern PTN1 flows from the power supply VDD to the V_LC side. In addition, a current I_lc2 flows to the power supply VDD because the common voltage VCOM is at 2VDD.

At this time, the respective current values are almost equal to each other from the following expression (4), and therefore the consumption current is zero as the total.

I_{—}lcl=Cload×VDD×1/T≈I_{—}lc2 (4)

FIGS. 9A and 9B show the voltage waveform and equivalent circuit in charge and discharge of the driving-subject capacitive load by the shutter driving device 100 according to the present embodiment.

The operation of power recovery is the same as that in the first driving operation pattern PTN1. Specifically, the voltage of the power recovery capacitor 121 is set to VDD/2 and transition to VDD/2 in charge and discharge is carried out by the power recovery capacitor 121.

At this time, the total current value is almost zero as described in the comparative example.

However, power recovery and reuse can be carried out as usual.

The operation when the driving-subject capacitive load is connected to the power supply VDD and the reference potential VSS is the same as the operation of the comparative example although the transition voltage is half, and the power consumption is almost zero as the total.

### [PTN3: Simultaneous Transition in the Same Direction in the Voltages of Both Ends of the Driving-Subject Capacitive Load]

Next, the third driving operation pattern PTN3, in which simultaneous transition in the same direction occurs in the voltages of both ends of the driving-subject capacitive load, will be described below.

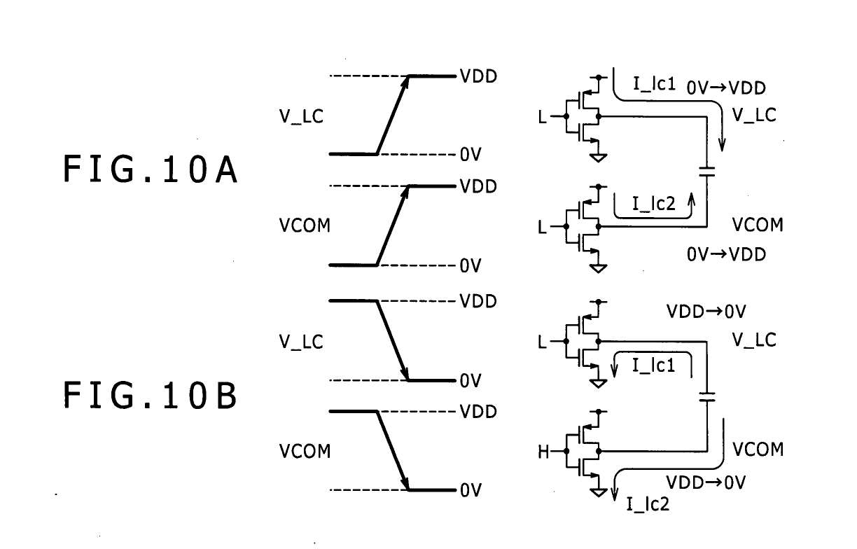

FIGS. 10A and 10B are diagrams for explaining operation and consumption current in the third driving operation pattern PTN3 in the comparative example.

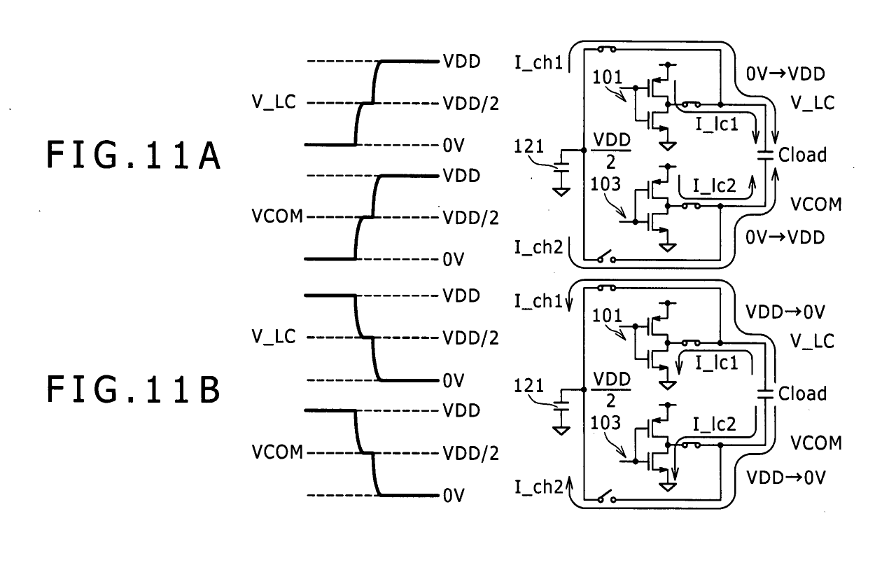

FIGS. 11A and 11B are diagrams for explaining operation and consumption current in the third driving operation pattern PTN3 in the present embodiment.

In the diagrams, I_lc denotes the driving-subject capacitive load current. I_ch denotes the power recovery current. Cload denotes the driving capacitance. VDD denotes a transition voltage. VDD/2 denotes a transition voltage.

FIGS. 10A and 10B show the waveform and equivalent circuit of the voltage transition operation in the comparative example.

FIG. 10A shows charge operation of the driving-subject capacitive load and FIG. 10B shows discharge operation of the driving-subject capacitive load.

In this operation, simultaneous transition in the same direction occurs in the voltages of both ends of the driving-subject capacitive load, and therefore charge movement occurs neither in charge nor in discharge. As a result, a current does not flow from the power supply VDD and the reference potential VSS and the consumption current is almost zero.

FIGS. 11A and 11B show the voltage waveform and equivalent circuit in charge and discharge of the driving-subject capacitive load by the shutter driving device 100 according to the present embodiment.

Charge movement does not occur in this operation as described for the comparative example. This is the same also in the operation of the power recovery circuit. Although substantially power recovery and reuse are not carried out because no current flows, power consumption also does not occur.

### [PTN4: Simultaneous Transition in the Reverse Directions in the Voltages of Both Ends of the Driving-Subject Capacitive Load]

Next, the fourth driving operation pattern PTN4, in which simultaneous transition in the reverse directions occurs in the voltages of both ends of the driving-subject capacitive load, will be described below.

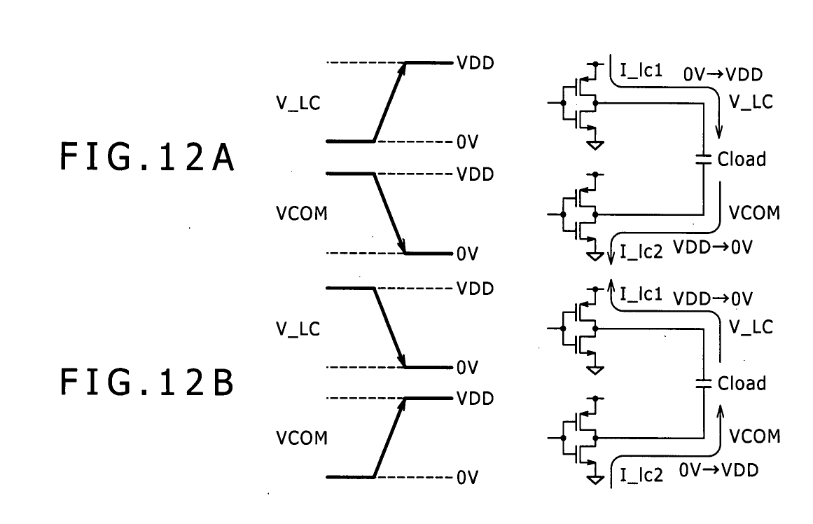

FIGS. 12A and 12B are diagrams for explaining operation and consumption current in the fourth driving operation pattern PTN4 in the comparative example.

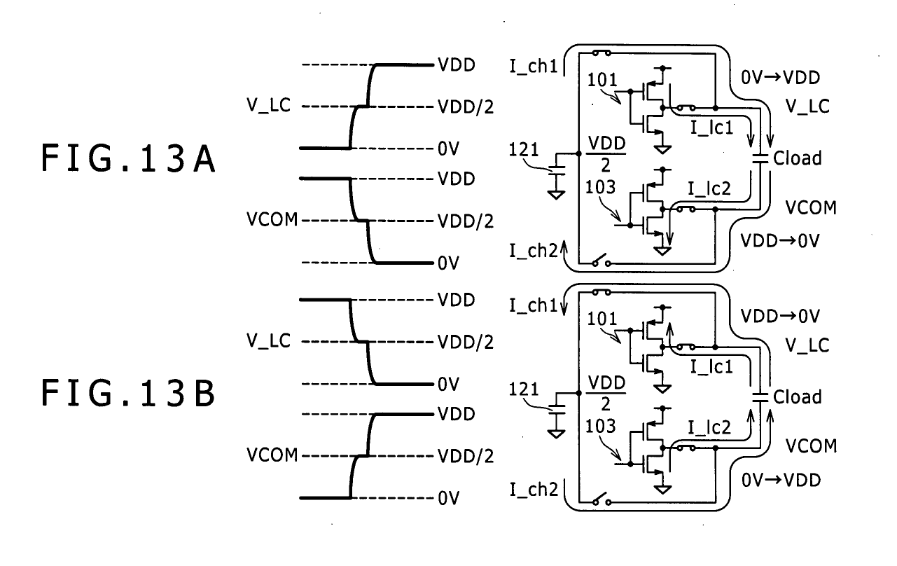

FIGS. 13A and 13B are diagrams for explaining operation and consumption current in the fourth driving operation pattern PTN4 in the present embodiment.

In the diagrams, I_lc denotes the driving-subject capacitive load current. I_ch denotes the power recovery current. Cload denotes the driving capacitance. VDD denotes a transition voltage. VDD/2 denotes a transition voltage.

FIGS. 12A and 12B show the waveform and equivalent circuit of the voltage transition operation in the comparative example. The operation patterns in these diagrams are in an inverted relationship.

In this case, in voltage transition, the voltages of both ends of the driving-subject capacitive load are inverted from each other and thus a charge twice as much as the charge in the case of transition of one of the voltages moves as the moving charge in the load.

Therefore, the consumption current value is twice as large as the current value represented for the first driving operation pattern PTN1 and is represented by the following equation. (5).

I_{—}lc1,2=Cload×2VDD×1/T (5)

FIGS. 13A and 13B show the voltage waveform and equivalent circuit in charge and discharge of the driving-subject capacitive load by the shutter driving device 100 according to the present embodiment.

The operation of power recovery is the same as that in the first driving operation pattern PTN1. Specifically, the voltage of the power recovery capacitor 121 is set to VDD/2 and transition to VDD/2 in charge and discharge is carried out by the power recovery capacitor 121.

Similarly to the comparative example, a charge twice as much as the charge in transition of one side moves because of simultaneous transition.

This applies also to power recovery. The current values in supply of the voltage VDD and in power recovery are represented by the following equations (6) and (7), respectively.

$$\begin{matrix}I\_lc1 = Cload \times \frac{2 VDD}{2} \times 1 / T & ( 6 ) \\ I\_ch1 = Cload \times \frac{2 VDD}{2} \times 1 / T & ( 7 )\end{matrix}$$

As a result, it turns out that the consumption current is about half that in the comparative example.

As for the power recovery current I_ch1, substantially the accumulated current is almost zero because the capacitor is simultaneously charged by I_ch2.

Eventually, a current is consumed in the first driving operation pattern PTN1 and the fourth driving operation pattern PTN4 among the above-described four patterns. However, the consumption current value is about half that in the comparative example in both patterns. Thus, the addition of the power recovery unit can realize power consumption reduction by about half as the total.

As described above, according to the first embodiment, the shutter driving device 36 has the power recovery function by use of a capacitor and switches for power consumption reduction and thus can realize great power consumption reduction by the power recovery function.

The driving control switches SD101 to SD104 to keep the output nodes of the clamp circuits 101 to 104 at high impedance (Hi-Z) may be omitted if the clamp circuit as a VDD/VSS connection switch is controlled based on ternary control.

Furthermore, plural capacitive loads can be connected to the power recovery capacitor. In this case, power is recovered at the transition timing of each of the capacitive loads.

### 2. Second Embodiment

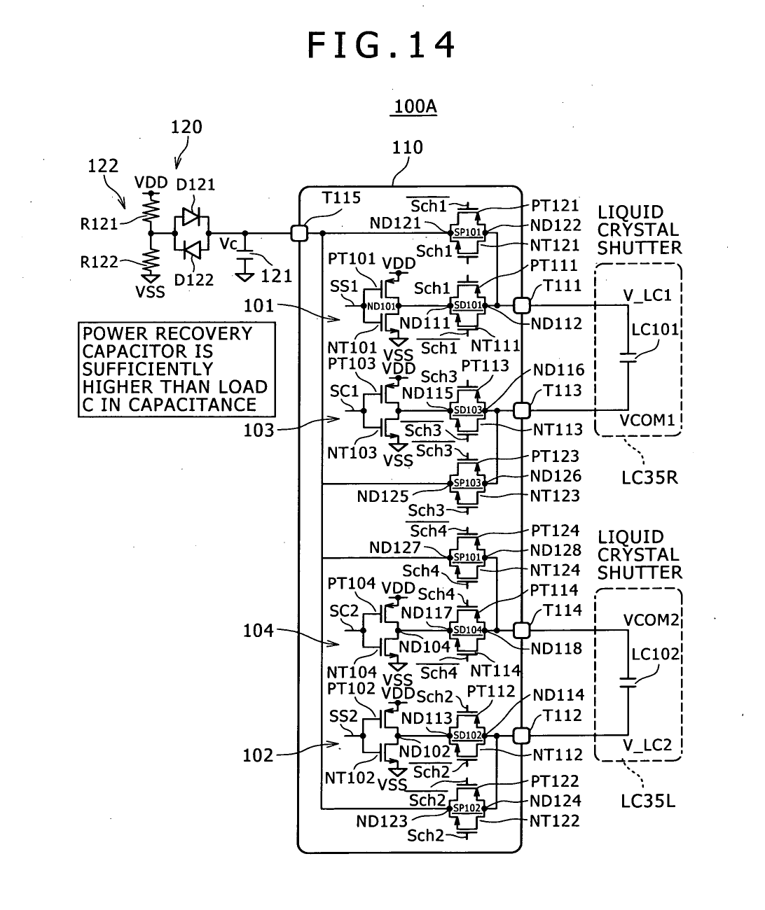

FIG. 14 is a circuit diagram showing a configuration example of a shutter driving device according to the second embodiment of the present invention.

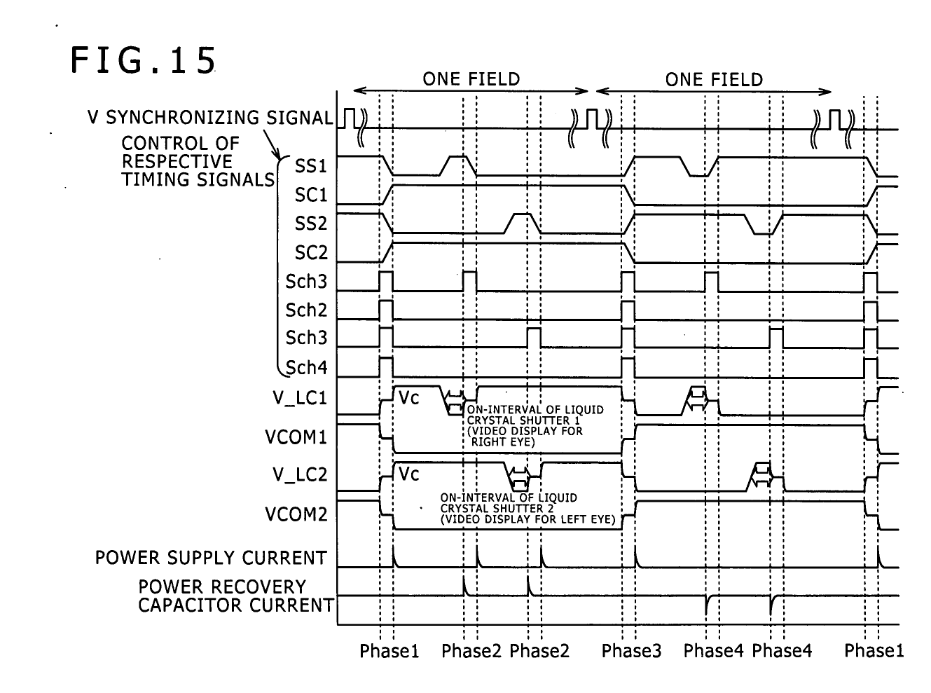

FIG. 15 is a timing chart for explaining the operation of the shutter driving device according to the second embodiment.

A shutter driving device 100A according to the second embodiment is different from the shutter driving device 100 according to the above-described first embodiment in that the configuration of the power supply 120 and the respective switches are shown as specific circuits.

The power supply 120 having the power recovery function has the power recovery capacitor 121, a reference voltage generator 122 based on resistive voltage-division by resistors R121 and R122, and reverse-current preventing diodes D121 and D122, as one example.

In the second embodiment, each of the first to fourth driving control switches SD101 to SD104 and the first to fourth recovery control switches SP101 to SP104 is configured by a transmission gate.

The first driving control switch SD101 is formed of a transmission gate obtained by connecting the sources and drains of a PMOS transistor PT111 and an NMOS transistor NT111 to each other.

A node ND111 is formed through connection of the drain of the PMOS transistor PT111 to the source of the NMOS transistor NT111. A node ND112 is formed through connection of the source of the PMOS transistor PT111 to the drain of the NMOS transistor NT111.

The gate of the PMOS transistor PT111 is connected to a supply line of the signal Sch1, and the gate of the NMOS transistor NT111 is connected to a supply line of the inverted signal S̅c̅h̅1̅ of the signal Sch1.

The node ND111 is connected to the node ND101 of the first clamp circuit 101 and the node ND112 is connected to the connection terminal T111.

The second driving control switch SD102 is formed of a transmission gate obtained by connecting the sources and drains of a PMOS transistor PT112 and an NMOS transistor NT112 to each other.

A node ND113 is formed through connection of the drain of the PMOS transistor PT112 to the source of the NMOS transistor NT112. A node ND114 is formed through connection of the source of the PMOS transistor PT112 to the drain of the NMOS transistor NT112.

The gate of the PMOS transistor PT112 is connected to a supply line of the signal Sch2, and the gate of the NMOS transistor NT112 is connected to a supply line of the inverted signal S̅c̅h̅2̅ of the signal Sch2.

The node ND113 is connected to the node ND102 of the second clamp circuit 102 and the node ND114 is connected to the connection terminal T112.

The third driving control switch SD103 is formed of a transmission gate obtained by connecting the sources and drains of a PMOS transistor PT113 and an NMOS transistor NT113 to each other.

A node ND115 is formed through connection of the drain of the PMOS transistor PT113 to the source of the NMOS transistor NT113. A node ND116 is formed through connection of the source of the PMOS transistor PT113 to the drain of the NMOS transistor NT113.

The gate of the PMOS transistor PT113 is connected to a supply line of the signal Sch3, and the gate of the NMOS transistor NT113 is connected to a supply line of the inverted signal S̅c̅h̅3̅ of the signal Sch3.

The node ND115 is connected to the node ND103 of the third clamp circuit 103 and the node ND116 is connected to the connection terminal T113.

The fourth driving control switch SD104 is formed of a transmission gate obtained by connecting the sources and drains of a PMOS transistor PT114 and an NMOS transistor NT114 to each other.

A node ND117 is formed through connection of the drain of the PMOS transistor PT114 to the source of the NMOS transistor NT114. A node ND118 is formed through connection of the source of the PMOS transistor PT114 to the drain of the NMOS transistor NT114.

The gate of the PMOS transistor PT114 is connected to a supply line of the signal Sch4, and the gate of the NMOS transistor NT114 is connected to a supply line of the inverted signal S̅c̅h̅4̅ of the signal Sch4.

The node ND117 is connected to the node ND104 of the fourth clamp circuit 104 and the node ND118 is connected to the connection terminal T114.

The first recovery control switch SP101 is formed of a transmission gate obtained by connecting the sources and drains of a PMOS transistor PT121 and an NMOS transistor NT121 to each other.

A node ND121 is formed through connection of the drain of the PMOS transistor PT121 to the source of the NMOS transistor NT121. A node ND122 is formed through connection of the source of the PMOS transistor PT121 to the drain of the NMOS transistor NT121.

The gate of the PMOS transistor PT121 is connected to a supply line of the inverted signal S̅c̅h̅1̅ of the signal Sch1, and the gate of the NMOS transistor NT121 is connected to a supply line of the signal Sch1.

The node ND121 is connected to the connection terminal T115 and the node ND122 is connected to the connection terminal T111.

The second recovery control switch SP102 is formed of a transmission gate obtained by connecting the sources and drains of a PMOS transistor PT122 and an NMOS transistor NT122 to each other.

A node ND123 is formed through connection of the drain of the PMOS transistor PT122 to the source of the NMOS transistor NT122. A node ND124 is formed through connection of the source of the PMOS transistor PT122 to the drain of the NMOS transistor NT122.

The gate of the PMOS transistor PT122 is connected to a supply line of the inverted signal S̅c̅h̅2̅ of the signal Sch2, and the gate of the NMOS transistor NT122 is connected to a supply line of the signal Sch2.

The node ND123 is connected to the connection terminal T115 and the node ND124 is connected to the connection terminal T112.

The third recovery control switch SP103 is formed of a transmission gate obtained by connecting the sources and drains of a PMOS transistor PT123 and an NMOS transistor NT123 to each other.

A node ND125 is formed through connection of the drain of the PMOS transistor PT123 to the source of the NMOS transistor NT123. A node ND126 is formed through connection of the source of the PMOS transistor PT123 to the drain of the NMOS transistor NT123.

The gate of the PMOS transistor PT123 is connected to a supply line of the inverted signal S̅c̅h̅3̅ of the signal Sch3, and the gate of the NMOS transistor NT123 is connected to a supply line of the signal Sch3.

The node ND125 is connected to the connection terminal T115 and the node ND126 is connected to the connection terminal T113.

The fourth recovery control switch SP104 is formed of a transmission gate obtained by connecting the sources and drains of a PMOS transistor PT124 and an NMOS transistor NT124 to each other.

A node ND127 is formed through connection of the drain of the PMOS transistor PT124 to the source of the NMOS transistor NT124. A node ND128 is formed through connection of the source of the PMOS transistor PT124 to the drain of the NMOS transistor NT124.

The gate of the PMOS transistor PT124 is connected to a supply line of the inverted signal S̅c̅h̅4̅ of the signal Sch4, and the gate of the NMOS transistor NT124 is connected to a supply line of the signal Sch4.

The node ND127 is connected to the connection terminal T115 and the node ND128 is connected to the connection terminal T114.

The operation of the shutter driving device 100A of FIG. 14 will be described below in association with FIG. 15.

FIG. 15 shows an operation pattern example of the signals (SS1, SS2, SC1, SC2, Sch1, Sch2, Sch3, Sch4) to drive the respective switches in FIG. 14, the waveform of the liquid crystal shutter control voltage V_LC, the waveform of the common voltage VCOM, the power supply current, and the current flowing through the power recovery unit.

First, the 3D-glasses main body 30 receives the vertical (V) synchronizing signal VSYNC from a TV and carries out operation.

By utilizing this V synchronizing signal as the trigger, charge and discharge of the driving-subject capacitive loads LC101 and LC102 of the LC (liquid crystal) shutters 35R and 35L are performed.

In setting of the potential V_LC of one end side of the driving-subject capacitive loads LC101 and LC102 to the high-level (Hi) potential, first, the signal Sch is set to Hi to turn on the recovery control switches SP101 to SP104. Thereby, the driving-subject capacitive loads are connected to the power recovery capacitor 121 and thereby charged. At this time, the driving control switches SD101 to SD104 are in the non-conductive state.

Upon the completion of transition to a desired voltage Vc by this connection, for the remaining transition, the signal Sch is set to the low level (Lo) to set the recovery control switches SP101 to SP104 to the non-conductive state and turn on the driving control switches SD101 to SD104. Furthermore, the signal SS is set to Lo to turn on the PMOS transistors PT101 and PT102 of the first and second clamp circuits 101 and 102. Thereby, the transition is carried out through charge from the power supply VDD.

The current consumed from the power supply VDD in this operation is lower by Vc compared with the case in which the power supply 120 serving as the power recovery unit is not used.

Also in transition of V_LC to the Lo potential, similarly, the signal Sch is set to the Hi potential to turn on the recovery control switches SP101 to SP104. Thereby, the driving-subject capacitive loads LC101 and LC102 are connected to the power recovery capacitor 121 and a charge is recovered from the loads.

The charge recovery causes the transition of the voltage of one end side of the driving-subject capacitive loads LC101 and LC102 to the desired voltage Vc.

For the remaining transition, the signal Sch is set to Lo, and the signal SS is set to Hi to turn on the NMOS transistors NT101 and NT102 of the first and second clamp circuits 101 and 102. Thereby, the driving-subject capacitive loads LC101 and LC102 are connected to the reference potential VSS and thereby a current is discharged from the loads.

The details of the respective transition patterns are as described above.

The operation patterns shown here include transition with power recovery and transition without power recovery. This transition without power recovery corresponds to the above-described operation in which the power consumption is almost zero. Therefore, recovery operation is not carried out in the present example.

Because the power recovery operation is operation completed through rising-up and falling-down on a certain one path, no problem is caused even when there is a path on which the power recovery operation is not carried out.

Also in this transition without power recovery, it is possible to perform power recovery.

### 3. Third Embodiment

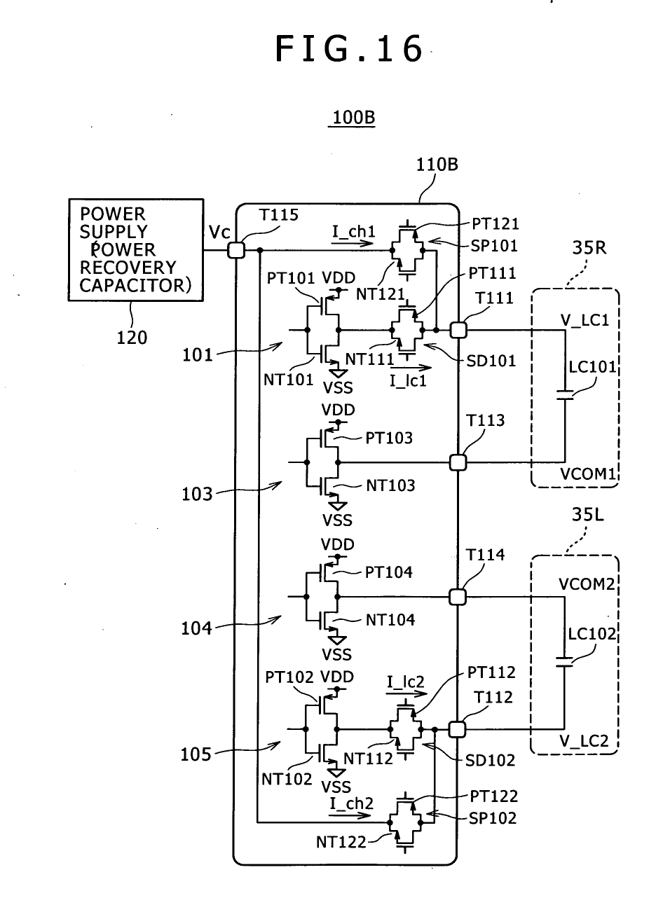

FIG. 16 is a circuit diagram showing a configuration example of a shutter driving device according to the third embodiment of the present invention.

A shutter driving device 100B according to the third embodiment is different from the shutter driving device 100A according to the second embodiment in the following point.

Specifically, in the shutter driving device 100B according to the third embodiment, the recovery paths PW101 and PW102 are formed for only one end side (V_LC side) of the driving-subject capacitive loads LC101 and LC102 and each one end side is connected to the power supply 120 serving as the power recovery unit.

Also as described for the second embodiment, the power recovery operation is completed on each path basis (recovery/reuse).

Therefore, it is also possible to add the power supply 120 as the power recovery unit to only one of the driving-subject capacitive loads LC101 and LC102.

In the third embodiment, the power supply 120 as the power recovery unit is added to only the V_LC side as an example. However, it is also possible to add the power supply 120 to only the other end side (VCOM side) of the driving-subject capacitive loads LC101 and LC102.

By suppressing the addition of the power supply 120 as the power recovery unit, the number of elements used can also be suppressed. As the effect when the power recovery mechanism is added to only the single side actually, in the third embodiment, the power consumption is reduced by about quarter of the power consumption in the comparative example, although the power consumption is reduced by about half in the second embodiment.

### 4. Fourth Embodiment

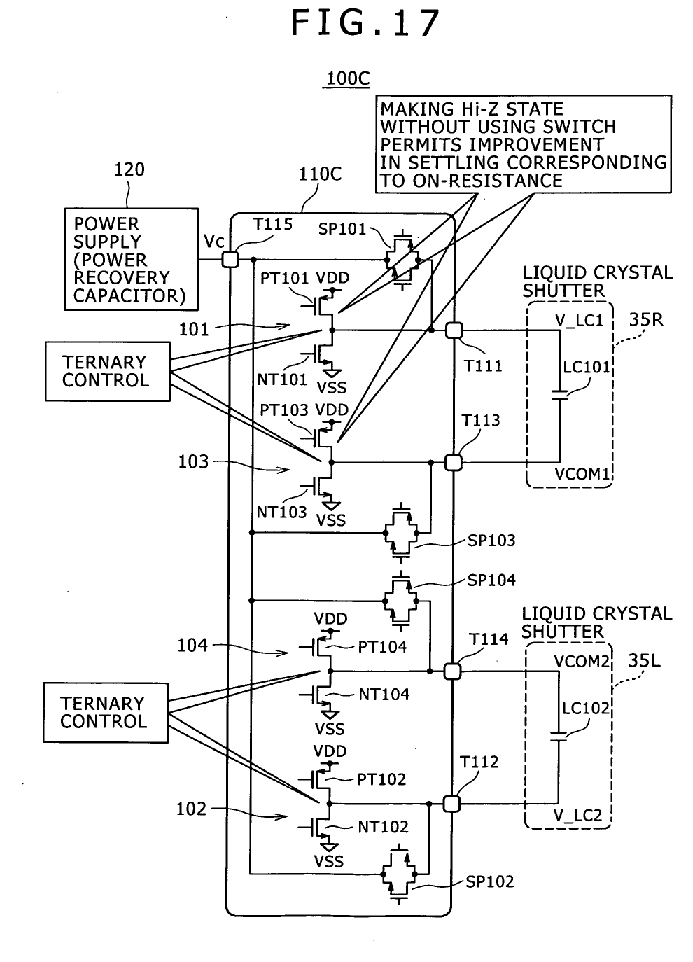

FIG. 17 is a circuit diagram showing a configuration example of a shutter driving device according to the fourth embodiment of the present invention.

A shutter driving device 100C according to the fourth embodiment is different from the shutter driving device 100A according to the second embodiment in the following point.

Specifically, in the shutter driving device 100C according to the fourth embodiment, the first to fourth driving control switches on the first to fourth driving paths PD101 to PD104 are not disposed.

In the second embodiment, operation of cutting off connection to the power supply VDD and the reference potential VSS in power recovery operation is carried out by the first to fourth driving control switches SD101 to SD104.

In contrast, in the fourth embodiment, the VDD and VSS connection switches of the first to fourth clamp circuits 101 to 104 are controlled based on ternary control, and the Hi-Z state is included in three control states. Due to this feature, the switches can be omitted and the number of elements used can be reduced.

Furthermore, the reduction in the number of switches decreases the resistance component of the path and thus leads also to improvement in the settling.

Three control states by the ternary control are as follows in the case of the first clamp circuit 101 for example. Specifically, in a first control state, the PMOS transistor PT101 is in the on-state and the NMOS transistor NT101 is in the off-state. Thus, clamping to the voltage VDD is performed.

In a second control state, the PMOS transistor PT101 is in the off-state and the NMOS transistor NT101 is in the on-state. Thus, clamping to the reference potential VSS is performed.

In a third control state, the PMOS transistor PT101 is in the off-state and the NMOS transistor NT101 is also in the off-state. Thus, the node ND101 of the first clamp circuit 101 is isolated from the power supply VDD and the reference potential VSS.

### 5. Fifth Embodiment

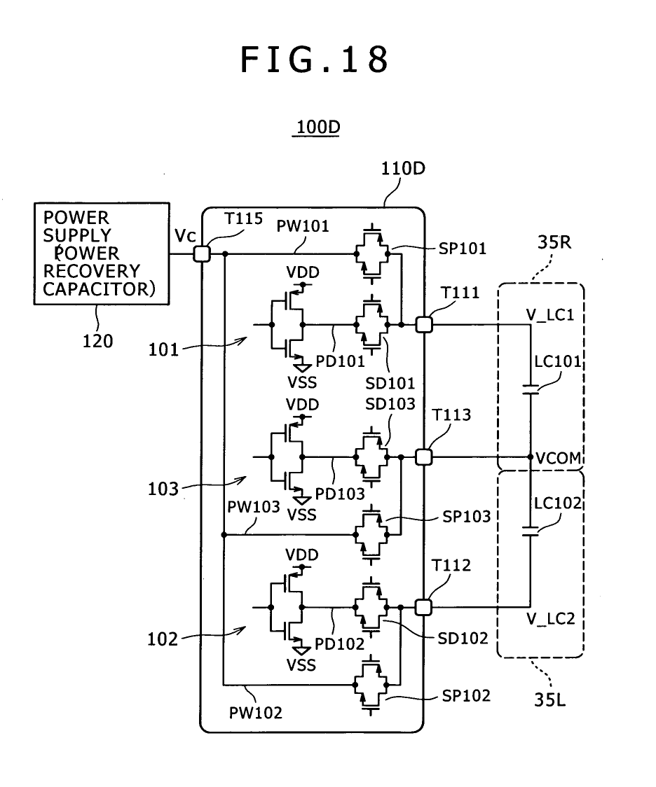

FIG. 18 is a circuit diagram showing a configuration example of a shutter driving device according to the fifth embodiment of the present invention.

A shutter driving device 100D according to the fifth embodiment is different from the shutter driving device 100A according to the second embodiment in that the VCOM paths, i.e. the third driving path PD103 and the fourth driving path PD104, are replaced by one common path.

For example if two VCOM operation waveforms are the same like in the operation pattern example shown in FIG. 15, it is also possible to replace the VCOM paths by one common path.

In FIG. 18, the driving control switches SD101 to SD104 to make the Hi-Z state are used.

However, as described above, it is also possible to omit the driving control switches SD101 to SD104 by controlling the VDD and VSS connection switches of the first to fourth clamp circuits 101 to 104 based on ternary control.

Furthermore, it is also possible to carry out power recovery on only a certain specific path, and e.g. a configuration in which only the addition of the power recovery mechanism to the VCOM side is omitted is also possible.

As described above, the embodiments of the present invention can achieve the following advantages.

By the addition of the power recovery function to the driver for liquid crystal driving in 3D glasses, power consumption reduction can be realized and the use time as a set can be greatly extended.

By the decrease in the number of terminals, cost reduction can be achieved.

By the sharing of the power recovery capacitor, which is an external part, reduction in the number of parts and cost reduction (set) are permitted.

By the decrease in the impedance, the power recovery efficiency can be enhanced and the use time as a set can be extended.

Increase in the chip size can be suppressed and reduction in the chip cost can be achieved.

The present application contains subject matter related to that disclosed in Japanese Priority Patent Application JP 2010-106391 filed with the Japan Patent Office on May 6, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A shutter driving device that drives a first shutter including a first driving-subject capacitive load and a second shutter including a second driving-subject capacitive load, the shutter driving device comprising:
a power recovery unit configured to have at one power recovery capacitor including a function to output an intermediate voltage between a supply potential and a reference potential and a power recovery function for recovering power;
a first driving path;
a second driving path;
a third driving path;
a first clamp circuit configured to be capable of clamping one end side of the first driving-subject capacitive load to the supply potential or the reference potential via the first driving path;
a second clamp circuit configured to be capable of clamping one end side of the second driving-subject capacitive load to the supply potential or the reference potential via the second driving path;
a third clamp circuit configured to be capable of clamping the other end side of the first driving-subject capacitive load and the other end side of the second driving-subject capacitive load to the supply potential or the reference potential via the third driving path;
a power recovery path configured to connect the power recovery capacitor to any of the one end side of the first driving-subject capacitive load, the one end side of the second driving-subject capacitive load, the other end side of the first driving-subject capacitive load, and the other end side of the second driving-subject capacitive load; and
a recovery control switch configured to be disposed on the power recovery path.

2. The shutter driving device according to claim 1, further comprising:
a controller configured to control the recovery control switch,
wherein the controller sets the recovery control switch to a conductive state when the intermediate voltage is output from the power recovery capacitor to the one end side or the other end side of the driving-subject capacitive load connected to the power recovery path or when power of the one end side or the other end side of the driving-subject capacitive load connected to the power recovery path is recovered to the power recovery capacitor.

3. The shutter driving device according to claim 2, wherein
the controller has a function to set, to a high-impedance state, output of the clamp circuit connected to the one end side or the other end side of the driving-subject capacitive load connected to the power recovery path on which the recovery control switch is disposed when setting the recovery control switch to a conductive state.

4. The shutter driving device according to claim 2, further comprising:
a driving control switch configured to be disposed on the driving path connected to the one end side or the other end side of the driving-subject capacitive load connected to the power recovery path on which the recovery control switch is disposed,
wherein the controller sets the driving control switch to a non-conductive state when setting the recovery control switch to a conductive state.

5. The shutter driving device according to claim 3, wherein
each of the clamp circuits includes a power-supply-side connection switch that connects the driving path connected to the clamp circuit to the supply potential, and a reference-side connection switch that connects the driving path connected to the clamp circuit to the reference potential,
the controller sets the power-supply-side connection switch and the reference-side connection switch to a conductive state and a non-conductive state in a complementary manner in clamp operation, and
the controller sets the power-supply-side connection switch and the reference-side connection switch to a non-conductive state when setting the recovery control switch to a conductive state.

6. The shutter driving device according to claim 1, wherein
the third driving path includes a fourth driving path,
the third clamp circuit includes a fourth clamp circuit,
the third clamp circuit is capable of clamping the other end side of the first driving-subject capacitive load to the supply potential or the reference potential via the third driving path, and
the fourth clamp circuit is capable of clamping the other end side of the second driving-subject capacitive load to the supply potential or the reference potential via the fourth driving path.

7. The shutter driving device according to claim 1, wherein
one third driving path and one third clamp circuit are disposed, and
the other end side of the first driving-subject capacitive load and the other end side of the second driving-subject capacitive load are capable of being clamped to the supply potential or the reference potential via the third driving path.

8. A three-dimensional video display system comprising:
video display apparatus configured to include a display device; and
three-dimensional glasses configured to include a shutter driving device that drives a first shutter including a first driving-subject capacitive load and a second shutter including a second driving-subject capacitive load, and obtain three-dimensional stereoscopic view video through viewing of the display device, wherein
the video display apparatus includes a communication unit capable of transmitting a synchronizing signal of video to the three-dimensional glasses,
the three-dimensional glasses include
a communication unit capable of receiving a synchronizing signal transmitted from the communication unit of the video display apparatus, and
a controller that carries out driving control of the shutter driving device at a timing synchronized with the received synchronizing signal, and
the shutter driving device having
a power recovery unit having one power recovery capacitor including a function to output an intermediate voltage between a supply potential and a reference potential and a power recovery function for recovering power,
a first driving path,
a second driving path,
a third driving path,
a first clamp circuit capable of clamping one end side of the first driving-subject capacitive load to the supply potential or the reference potential via the first driving path,
a second clamp circuit capable of clamping one end side of the second driving-subject capacitive load to the supply potential or the reference potential via the second driving path,
a third clamp circuit capable of clamping the other end side of the first driving-subject capacitive load and the other end side of the second driving-subject capacitive load to the supply potential or the reference potential via the third driving path,
a power recovery path that connects the power recovery capacitor to any of the one end side of the first driving-subject capacitive load, the one end side of the second driving-subject capacitive load, the other end side of the first driving-subject capacitive load, and the other end side of the second driving-subject capacitive load, and
a recovery control switch disposed on the power recovery path.

9. The three-dimensional video display system according to claim 8, wherein
the shutter driving device has the controller that controls the recovery control switch, and
the controller sets the recovery control switch to a conductive state when the intermediate voltage is output from the power recovery capacitor to the one end side or the other end side of the driving-subject capacitive load connected to the power recovery path or when power of the one end side or the other end side of the driving-subject capacitive load connected to the power recovery path is recovered to the power recovery capacitor.

10. The three-dimensional video display system according to claim 9, wherein
the controller has a function to set, to a high-impedance state, output of the clamp circuit connected to the one end side or the other end side of the driving-subject capacitive load connected to the power recovery path on which the recovery control switch is disposed when setting the recovery control switch to a conductive state.

11. The three-dimensional video display system according to claim 9, wherein
the shutter driving device has a driving control switch disposed on the driving path connected to the one end side or the other end side of the driving-subject capacitive load connected to the power recovery path on which the recovery control switch is disposed, and
the controller sets the driving control switch to a non-conductive state when setting the recovery control switch to a conductive state.

12. The three-dimensional video display system according to claim 10, wherein
each of the clamp circuits includes a power-supply-side connection switch that connects the driving path connected to the clamp circuit to the supply potential, and a reference-side connection switch that connects the driving path connected to the clamp circuit to the reference potential,
the controller sets the power-supply-side connection switch and the reference-side connection switch to a conductive state and a non-conductive state in a complementary manner in clamp operation, and
the controller sets the power-supply-side connection switch and the reference-side connection switch to a non-conductive state when setting the recovery control switch to a conductive state.

13. The three-dimensional video display system according to claim 8, wherein
the third driving path includes a fourth driving path,
the third clamp circuit includes a fourth clamp circuit,
the third clamp circuit is capable of clamping the other end side of the first driving-subject capacitive load to the supply potential or the reference potential via the third driving path, and
the fourth clamp circuit is capable of clamping the other end side of the second driving-subject capacitive load to the supply potential or the reference potential via the fourth driving path.

14. The three-dimensional video display system according to claim 8, wherein
one third driving path and one third clamp circuit are disposed, and
the other end side of the first driving-subject capacitive load and the other end side of the second driving-subject capacitive load are capable of being clamped to the supply potential or the reference potential via the third driving path.
